(19) United States
(12) Patent Application Publication
(10) Pub. No.: US 2006/0283878 A1
(43) Pub. Date: Dec. 21, 2006

(54) Device for automatically supplying a liquid to dry and wet batteries

(76) Inventor: Jen-Chin Chen, Kaohsiung City (TW)

Correspondence Address: BIRCH STEWART KOLASCH & BIRCH, PO BOX 747, FALLS CHURCH, VA, 22040-0747, US

(21) Appl. No.: 11/155,481

(22) Filed: Jun. 20, 2005

(51) Int. Cl. B67D 5/00

(52) U.S. Cl. 222/80

(57) ABSTRACT

A liquid supplying device of the prevent invention is adapted for automatically supplying a liquid to dry and wet batteries when an electrolyte solution evaporates. The interior of the cover plate is provided with an input tube and an output tube which both bulged out a side of the cover plate. The cover plate is provided with input terminals, wherein the distance between the two adjacent input terminals is the same. Protrudent blocks are respectively disposed around the input terminals. A floating body is pivotally mounted at the protrudent block. When an electrolyte solution of the battery evaporates and each floating body floats downward because the level is low, the pressing block of each floating body escapes from a protrudent rod of the syringe, and simultaneously a needle end of the syringe opens an input hole of the input tube to form an open circuit and keep a safety level.

### FIELD OF THE INVENTION

The present invention relates to a device for automatically supplying a liquid to dry and wet batteries, and more particularly to a device for automatically supplying a liquid to dry and wet batteries, wherein a pressing block of each floating body contacts or escapes from a protrudent rod of the syringe, and simultaneously the needle end closes or opens the input hole so as to keep a safety level.

### BACKGROUND OF THE INVENTION

Recently, all dry battery and wet battery of alternating current (AC) and direct current (DC) applied to a vehicle need water which serve as a medium for electrolyte. In order to increase the lifetime of the dry battery and wet battery, a user needs to regularly check and supply an electrolyte solution and charges the dry battery and wet battery. However, in an actual embodiment, the user often forgot to supply the electrolyte solution such that the electrolyte solution evaporates to be empty. When the electrolyte solution is requested to be supplied, the user must take away each granular cap of battery chamber and supply the electrolyte solution via flexible tube. If the user forgot to maintain components of his car such as battery, the components may be fail or the power of the battery is too low to start the car. Then, the user must request a repairman to supply an electrolyte solution and charges the battery so as to start the car. Thus, it is inconvenient, affects the lifetime of the dry battery and wet battery, and increases the cost.

Accordingly, there exists a need for a device for automatically supplying a liquid to dry and wet batteries to solve the above-mentioned disadvantages, e.g. the user needs to regularly supply an electrolyte solution, the user needs to regularly check an electrolyte solution before the user drives a car, and conventional dry and wet batteries sold in the market cannot be standby long time and have increased work time.

### SUMMARY OF THE INVENTION

It is an object of the present invention provides a device for automatically supplying a liquid to dry and wet batteries, wherein the needle end closes or opens the input hole when each floating body floats upward or downward because the level is high or low.

It is another object of the present invention provides a device for automatically supplying a liquid to dry and wet batteries, wherein the interior of the cover plate is provided with an input tube and an output tube which both bulged out a side of the cover plate. The cover plate is provided with input terminals, wherein the distance between the two adjacent input terminals is the same. Protrudent blocks are respectively disposed around the input terminals. A floating body is pivotally mounted at the protrudent block. When an electrolyte solution of the battery evaporates and then each floating body floats downward because the level is low, the pressing block of each floating body escapes from a protrudent rod of the syringe, and simultaneously a needle end of the syringe opens an input hole of the input tube so as to form an open circuit.

It is a further object of the present invention provides a device for automatically supplying a liquid to dry and wet batteries, wherein the input tube is connected to a water supplying tank via an external tube, and the output tube is connected to a water storing tank having a level switch via an external tube. The excessive electrolyte solution is supplied back to the water supplying tank by driving a motor, thereby instantly automatically supplying a liquid to the battery when the electrolyte solution evaporates. Thus, when the electrolyte solution is requested to be supplied, the user does not need to take away each granular cap of battery chamber and supply the electrolyte solution via flexible tube.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a block diagram showing the arrangement of the present invention.

FIG. 2 is an exploded perspective view of the present invention.

FIG. 3 is a perspective view showing the combination of the present invention.

FIG. 4A is a top plan view showing the combination of the present invention.

FIG. 4B is an expanded top plan view showing an input hole shown in FIG. 4A.

FIG. 5 is a sectional view showing the level is low when the electrolyte solution evaporates.

FIG. 6 is a sectional view showing the electrolyte solution which is supplied.

### DETAILED DESCRIPTION OF THE PREFERRED EMBODIMENTS

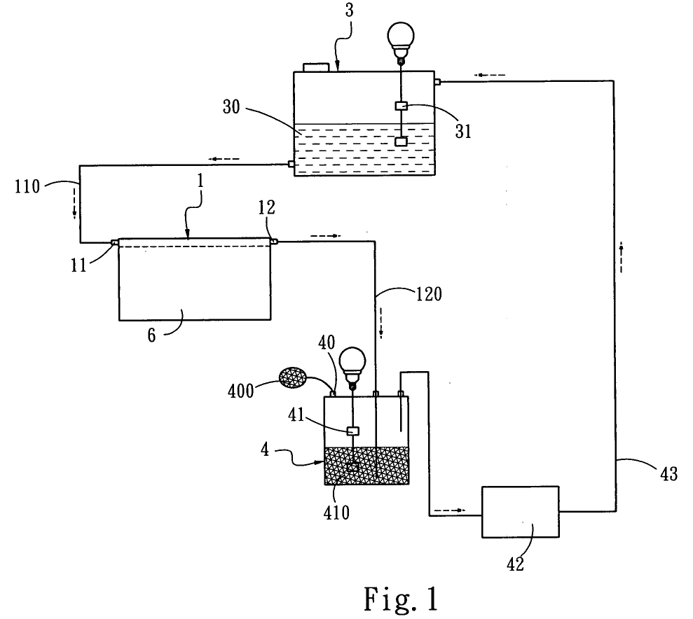

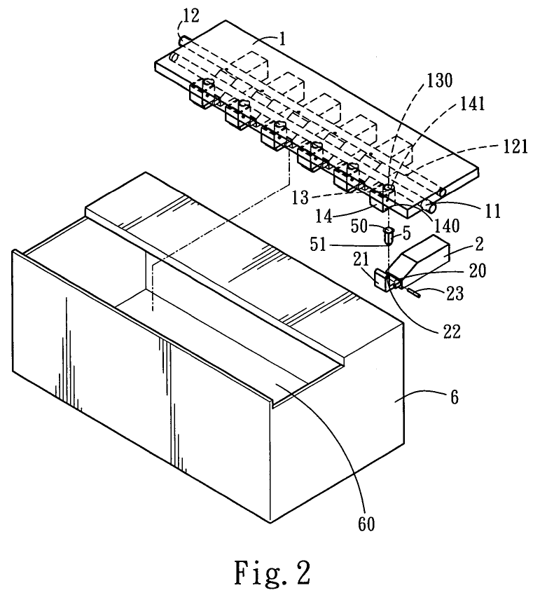

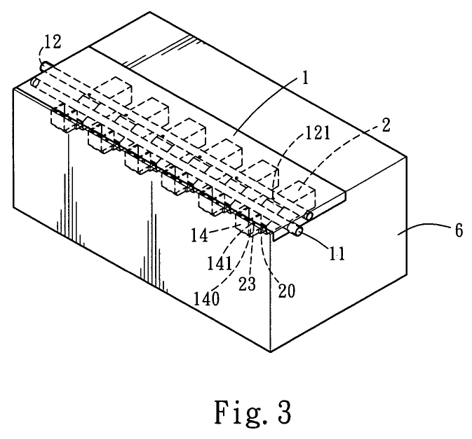

Referring to FIG. 1, it depicts the arrangement of a liquid supplying device of the prevent invention. As shown in figure, the liquid supplying device includes a cover plate 1 and a plurality of floating bodies 2. The interior of the cover plate 1 is provided with an input tube 11 and an output tube 12 which both bulged out a side of the cover plate 1. Also, the inner surface of the cover plate 1 is provided with a plurality of input terminals 13, wherein the distance between the two adjacent input terminals 13 is the same. The inner surface of the cover plate 1 is provided with a plurality of protrudent blocks 14 respectively disposed around the input terminals 13. The floating body 2 is pivotally mounted at the protrudent block 14 of the cover plate 1. The input tube 11 is connected to a water supplying tank 3 via an external tube 110, and the output tube 12 is connected to a water storing tank 4 via an external tube 120. The top of the water storing tank 4 is provided with a vent hole 40 of an air filter 400 and a high level warning floating light 41. The interior of the water storing tank 4 is provided with a filter 410. A side of the water storing tank 4 is provided with a motor 42 and a tube 43 connected to the water supplying tank 3 which has a low level warning floating light 31. An electrolyte solution 30 is disposed in a battery 6, such as dry and wet batteries. When the level of the electrolyte solution 30 of the battery 6 evaporating is low and warned by the low level warning floating light 31, then the water supplying tank 3 is informed to supply enough the electrolyte solution 30 for the battery 6. The supplied electrolyte solution 30 flows through the external tube 110, the input tube 11 of the cover plate 1 and individual input terminal 13 in sequence. If the battery 6 overflows with the supplied electrolyte solution 30 (or the electrolyte solution 30 has dirt), the overflowed electrolyte solution 30 flows through the water storing tank 4 via an external tube 120. The filter 410 of the water storing tank 4 filters the overflowed electrolyte solution 30. The air filter 400 of the water storing tank 4 filters a dirty air and then the vent hole 40 of the water storing tank 4 vents the dirty air. When the high level warning floating light 41 of the water storing tank 4 shows that the water storing tank 4 is full of the electrolyte solution 30, the electrolyte solution 30 is supplied back to the water supplying tank 3 via the tube 43 by driving the motor 42.

The above-mentioned cover plate 1 (referring to FIGS, 2 and 3) is integrally formed, and the interior of the cover plate 1 is provided with the input tube 11 and the output tube 12 which are not interconnected to each other and both bulged out the side of the cover plate 1. The inner surface of the cover plate 1 is provided with the input terminals 13, wherein the distance between the two adjacent input terminals 13 is the same. The input terminal 13 has an accommodating space 130 in the interior thereof, a groove 132 located around the accommodating space 130, and a input hole 131 connected to the input tube 11. A syringe 5 includes a soft needle end 50 (the shape of the needle end can be triangular, obliquely conical and planar) disposed at an end thereof for inserting into the accommodating space 130. The syringe 5 includes a protrudent rod 51 disposed at the other end thereof. The protrudent block 14 is disposed around the input terminals 13. The corresponding side 140 of the protrudent block 14 is provided with an axial hole 141. The inner surface of the output tube 12 of the cover plate 1 is provided with a vent hole 121 corresponding to the input terminals 13 for venting air.

The floating body 2 is hollow and is provided with a pressing block 20 expanding from an end thereof. The pressing block 20 is provided with an inserting block 21 downward expanding from an end thereof. The inserting block 21 is provided with a through hole 22. An axial rod 23 passes through the through hole 22, whereby the inserting block 21 of the floating body 2 is pivotally mounted at the protrudent block 14 of the cover plate 1. The inserting block 21 is rotated around the axial rod 23, such that the floating body 2 floats upward or downward when the level of the electrolyte solution 30 of the battery 6.

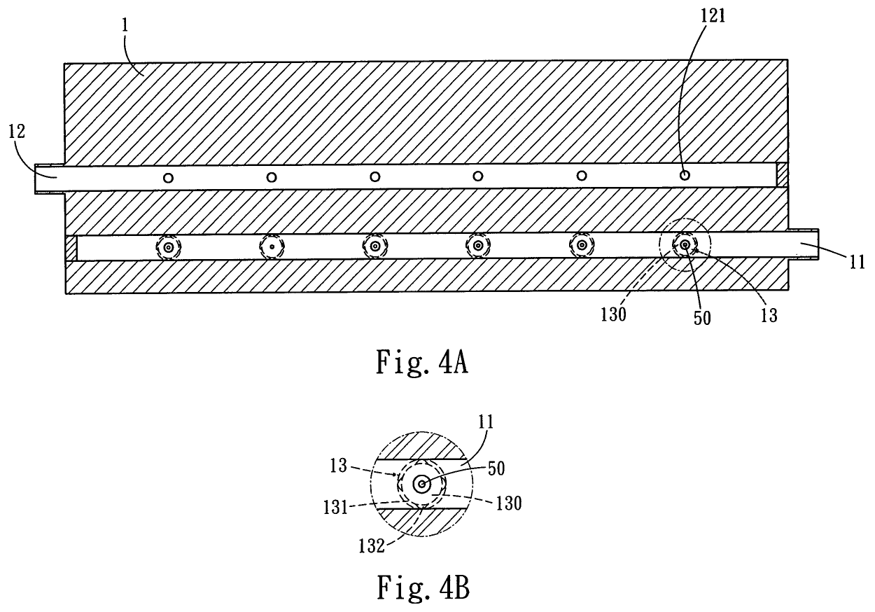

Referring to FIGS. 4A and 4B, they show a combination. The syringe 5 is disposed at the center of the accommodating space 130 of the input terminals 13 of the inner surface of the cover plate 1 of the present invention, such that the protrudent rod 51 disposed at the other end of the syringe 5 faces outward, and the soft needle end 50 disposed at the end of the syringe 5 faces the input hole 131. The floating body 2 is pivotally mounted at the protrudent block 414. When the pressing block 20 of the floating body 2 contacts the protrudent rod 51 of the syringe 5, the needle end 50 of the syringe 5 closes the input hole 131 of the input tube 11. Then, an accommodating chamber 60 located upper the battery 6 is covered with the cover plate 1.

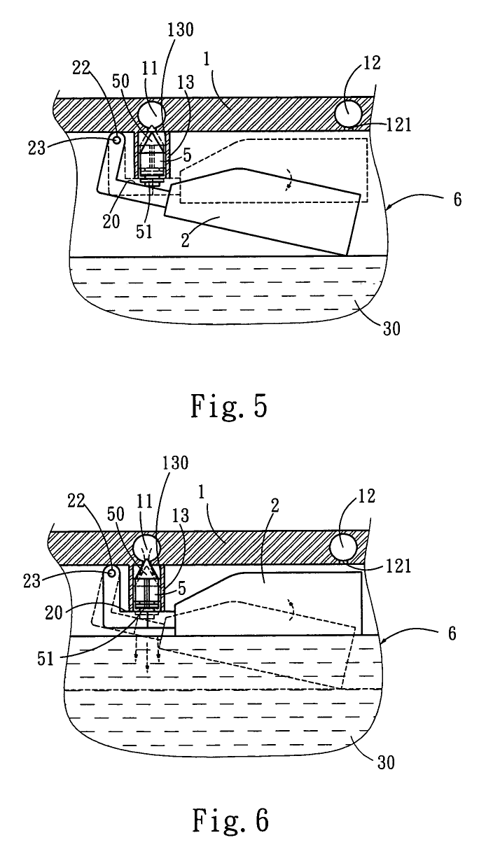

Referring to FIG. 5, it shows the operation. When an electrolyte solution of the battery 6 evaporates and then each floating body 2 floats downward because the level is low, the pressing block 20 of each floating body 2 escapes from the protrudent rod 51 of the syringe 5. Simultaneously, the needle end 50 of the syringe 5 opens the input hole 131 of the input tube 11 so as to form an open circuit. The input tube 11 of the cover plate 1 is connected to the water supplying tank 3 via the external tube 110. The water supplying tank 3 supplies the electrolyte solution 30 into the cover plate 1 via the external tube 110. The supplied electrolyte solution 30 flows through the input tube 11 and the input hole 130 of each input terminal 13. Each floating body 2 floats upward because the level of the electrolyte solution 30 is high. When the pressing block 20 of the floating body 2 contacts the protrudent rod 51 of the syringe 5, the needle end 50 of the syringe 5 closes the input hole 131 of the input tube 11 so as to form a closed circuit (shown in FIG. 6). When the battery 6 overflows with the supplied electrolyte solution 30, the overflowed electrolyte solution 30 flows through the water storing tank 4 via an external tube 120 connected to the output tube 12 as shown in FIG. 1. The electrolyte solution 30 of the water storing tank 4 is supplied back to the water supplying tank 3 via the tube 43 by driving the motor 42.

In conclusion, a liquid supplying device of the prevent invention is adapted for automatically supplying a liquid to dry and wet batteries so as to keep a safety level. The pressing block 20 contact or escapes from the syringe 5, and simultaneously the needle end 50 closes or opens the input hole 131 so as to achieve an object for automatically supplying the electrolyte solution 30.

Although the invention has been explained in relation to its preferred embodiment, it is not used to restrain the invention. It is to be understood that many other possible modifications and variations can be made by those skilled in the art without departing from the spirit and scope of the invention as hereinafter claimed.

What is claimed is:

1. A device for automatically supplying a liquid to a battery, the device comprising:
a cover plate provided with an input tube and an output tube both disposed therein and bulged out a side thereof, provided with an input terminal having an accommodating space and a input hole disposed therein, provided with a protrudent block disposed around the input terminals, wherein the corresponding side of the protrudent block is provided with an axial hole;
a floating body provided with a pressing block expanding from an end thereof, wherein the pressing block is provided with an inserting block downward expanding from an end thereof, the inserting block is provided with a through hole and an axial rod passing through the through hole, whereby the inserting block is pivotally mounted at the protrudent block; and
a syringe including a needle end and a protrudent rod, wherein the needle end disposed at an end of the protrudent rod faces the input hole, and the protrudent rod disposed at the other end of the syringe faces outward.

2. The device for automatically supplying a liquid to a battery according to claim 1, wherein the input tube and the output tube are not interconnected to each other.

3. The device for automatically supplying a liquid to a battery according to claim 1, wherein an inner surface of the output tube is provided with a vent hole corresponding to the input hole.

4. The device for automatically supplying a liquid to a battery according to claim 1, wherein the input terminal has a groove located around the accommodating space for connecting the input hole to the input tube.

5. The device for automatically supplying a liquid to a battery according to claim 1, wherein the corresponding side of the protrudent block is provided with an axial hole.

6. The device for automatically supplying a liquid to a battery according to claim 1, wherein the floating body is hollow.

7. The device for automatically supplying a liquid to a battery according to claim 1, wherein the needle end of the protrudent rod is soft.
